(19) United States
(12) Patent Application Publication
(10) Pub. No.: US 2009/0177633 A1
(43) Pub. Date: Jul. 9, 2009

(54) QUERY EXPANSION OF PROPERTIES FOR VIDEO RETRIEVAL

(76) Inventors: Chumki Basu, East Brunswick, NJ (US); Hui Cheng, Bridgewater, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 12/332,661

(22) Filed: Dec. 11, 2008

Related U.S. Application Data
(60) Provisional application No. 61/013,192, filed on Dec. 12, 2007.

(51) Int. Cl. G06F 17/30

(52) U.S. Cl. 707/3; 707/E17.014

(57) ABSTRACT

A computer implemented method for retrieving video clips from a database is disclosed. The method may include retrieving in an initial query from a video collection based on a search term; receiving a user selection of at least one video clip from a first set of video clips corresponding to the search term; associating at least one visual attribute of the selected video clip with the search term; receiving the at least one search term from a user in a subsequent query; determining a set of physical concepts based on the at least one search term; mapping the set of physical concepts to a plurality of visual attributes; searching the database for at least one video clip corresponding to the plurality of visual attributes; identifying at least one video clip in the database having the plurality of visual attributes; and returning a second set of video clips having the set of visual attributes to the user, the second set including the at least one video clip.

### CROSS-REFERENCE TO RELATED APPLICATIONS

This application claims the benefit of U.S. provisional patent application No. 61/013,192 filed Dec. 12, 2007, the disclosure of which is incorporated herein by reference in its entirety.

### GOVERNMENT RIGHTS IN THIS INVENTION

This invention was made with U.S. government support under contract number NBCHC070062. The U.S. government has certain rights in this invention.

### FIELD OF THE INVENTION

The present invention relates generally to vision systems, and more particularly, to a method and apparatus for searching videos based on a mapping from a set of physical concepts to visual properties or descriptors, without requiring the user to know the underlying properties and their values, or perform the translation manually.

### BACKGROUND OF THE INVENTION

Database searching tools exist for all sorts of queries, including video. When an user is searching for objects in video clips stored in a video database, the most natural query consists of nouns representing concepts such as, for example, “person,” “vehicle,” “convoy,” or “building.” Similarly, activities are represented by combinations of nouns and verbs such as “vehicle”/“turn.” This is the model followed by some popular video search tools, such as Google Video™. In a Google Video™ keyword search, the search term(s) need to match a caption/annotation associated with a video clip in a video database. Once again, vocabulary mismatch presents a key challenge if the user query must be compared against video annotations. For example, if the video is not annotated with the same keywords, then no result will be returned.

Retrieval performance may be improved over the method of searching with simple keyword search terms that are matched to video annotations. One method that is well-documented in the information retrieval literature is known as query expansion. In the text retrieval domain, a number of highly-ranked documents (i.e., document content) are reissued as a new query, thereby expanding the query with additional query terms. In the video retrieval domain, there is also a body of computer vision literature devoted to query expansion. In “Total Recall: Automatic Query Expansion with a Generative Feature Model for Object Retrieval,” (0. Chum, J. Philbin, J. Sivic, M. Isard, and A. Zisserman), ICME, 2007, (Chum et al.), a bag-of-visual-words architecture is adopted to achieve high precision. Chum et al. also presents two contributions to query expansion—the use of strong spatial constraints between image and each result and learning of a latent feature model from the images. The drawback of the approach of Chum et al. is that feature detection and quantization are noisy processes, leading to variation in the visual words and consequently missed results. In “Semantic Concept-Based Query Expansion and Re-ranking for Multimedia Retrieval,” (A. Natsev, A. Haubold, J. Tesic, L. Xi, and R. Yan), ACM Multimedia, 2007, (Natsev et al.), approaches for query expansion are presented in which textual keywords, visual examples or initial retrieval results are analyzed to identify the most relevant visual concepts for a given query. The approaches of Natsev et al. are both lexical and involve statistical corpus analysis, which require deep parsing or semantic tagging of queries or lexical query expansion. In “Enabling Video Annotation Using a Semantic Database Extended with Visual Knowledge,” (G. Stein, J. Rittscher, A. Hoogs), ICME, 2003, (“Stein et al.”), an extension to WordNet is described that contains specific visual information (WordNet is a semantic lexicon for the English language. It groups English words into sets of synonyms called synsets, provides short, general definitions, and records the various semantic relations between these synonym sets. WordNet was created and has been maintained at the Cognitive Science Laboratory of Princeton University, Princeton, N.J.). However, the Stein et al. paper focuses on how such a semantic database makes video annotation possible for Broadcast News. In “Creating a Geospatial and Visual Information Ontology for Users,” (C. Basu, H. Cheng, C. Fellbaum), Ontology for the Intelligence Community, 2007 (“the GVIO paper”), which is incorporated herein by reference in its entirety, an extension to WordNet is also developed. The focus of the GVIO paper is on a different aspect of query expansion than is presented in the present invention.

Accordingly, what would be desirable, but has not yet been provided, is a system and method for effectively and automatically searching for, identifying, and retrieving high precision video clips from a database based on a mapping of a set of physical concepts to visual properties or descriptors.

### SUMMARY OF THE INVENTION

The above-described problems are addressed and a technical solution is achieved in the art by providing a computer implemented method for retrieving video clips from a database, comprising the steps of retrieving in an initial query from a video collection based on a search term; receiving a user selection of at least one video clip from a first set of video clips corresponding to the search term; associating at least one visual attribute of the selected video clip with the search term; receiving the at least one search term from a user in a subsequent query; determining a set of physical concepts based on the at least one search term; mapping the set of physical concepts to a plurality of visual attributes; searching the database for at least one video clip corresponding to the plurality of visual attributes; identifying at least one video clip in the database having the plurality of visual attributes; and returning a second set of video clips having the set of visual attributes to the user, the second set including the at least one video clip. The second set may contain fewer video clips than the first set. According to an embodiment of the present invention, determining a set of physical concepts and mapping the set of physical concepts may be performed using a taxonomy and an inference engine. Determining a set of physical concepts may further comprise finding synonyms of the search term for use in determining the set of physical concepts. The method may further comprise the step of querying a plurality of collections of video clips in the database, wherein the range of values for a given visual attribute is the union of values that covers substantially all video clips having said given visual attribute across the plurality of collections of video clips. At least one of the plurality of visual attributes may be derived from sensor metadata stored with at least one of the second set of video clips. At least one of the plurality of visual attributes may be associated with the selected video clip.

According to an embodiment of the present invention, the method may further comprise the steps of extracting at least one actual value of at least one of the plurality of visual attributes for which at least one default value has been assigned in the taxonomy; associating with the at least one actual value at least one other visual attribute from the second set of video clips; and annotating the taxonomy with the at least one other associated visual attribute when available from a user selected video clip. The retrieval method may further comprise the steps of receiving the at least one search term from the user; determining a second set of physical concepts based on the at least one search term; mapping the second set of physical concepts to a second plurality of visual attributes based on the annotated taxonomy; searching the database for at least one video corresponding to the second plurality of visual attributes; identifying at least one video clip in the database having the second plurality of visual attributes; and returning a third set of video clips having the second plurality of visual attributes to the user, the third set including the at least one video clip. The third set may contain fewer video clips than the second set.

Default values may be assigned to the plurality of visual attributes, the default value being computed based on a collection of training video clips. Minimum and maximum values of visual attributes in the plurality of visual attributes may be pre-computed. A value corresponding to each of the plurality of visual attributes may be derived from metadata contained within a collection of training video clips.

### BRIEF DESCRIPTION OF THE DRAWINGS

The present invention will be more readily understood from the detailed description of exemplary embodiments presented below considered in conjunction with the attached drawings, of which:

FIG. 1 is a block diagram of an exemplary hardware architecture of a system for retrieving video clips from a database, constructed in accordance with an embodiment of the present invention;

FIG. 2 is a flowchart of the steps of the computer implemented method for retrieving video clips from a database, constructed in accordance with an embodiment of the present invention;

FIG. 3 is a screen shot of an illustrative example of a search panel according to an embodiment of the present invention that shows the kinds of default visual attributes that can be returned in a query in real-time;

FIG. 4 is a flow chart illustrating an exemplary process flow for populating the visual attributes in the search panel with default values shown in FIG. 3;

FIG. 5 is a screen shot of a sample result panel displayed upon the execution of the process illustrated in FIG. 4;

FIG. 6 is a flow chart depicting a process flow for augmenting the process of query expansion depicted FIG. 2 according to an embodiment of the present invention, thereby increasing the precision of the resulting set of retrieved video clips; and

FIG. 7 illustrates an exemplary method for performing an additional search based on the concepts searched according to the process flow of FIG. 2.

It is to be understood that the attached drawings are for purposes of illustrating the concepts of the invention and may not be to scale.

### DETAILED DESCRIPTION OF THE INVENTION

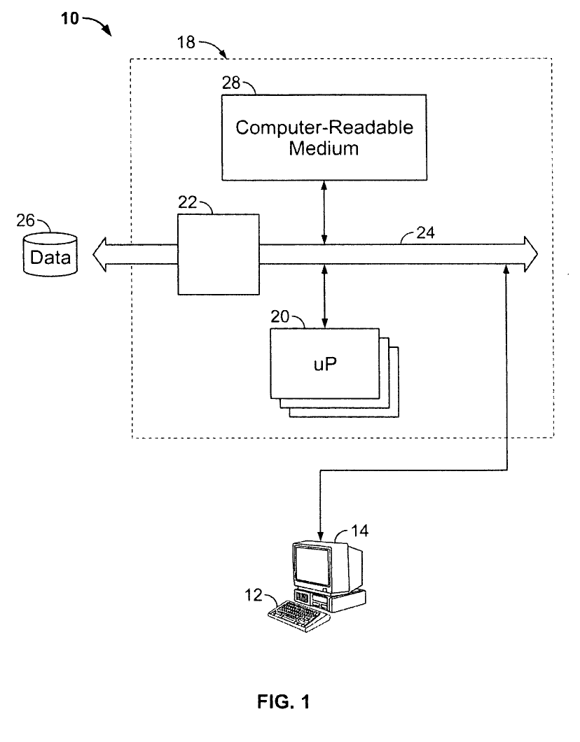

Referring now to FIG. 1, an illustrative embodiment of a system for retrieving video clips from a database is depicted, generally indicated at 10. As used herein, unless otherwise noted, the term “video clip” may refer to either a single still image, a plurality of consecutive images from a portion of a video, or an entire video. By way of a non-limiting example, the system 10 receives input from a terminal device 12 for inputting queries which may include a display device 14. The system 10 may comprise a computing platform 18. The computing platform 18 may include a personal computer or work-station (e.g., a Pentium-M 1.8 GHz PC-104 or higher) comprising one or more processors 20 which includes a bus system 22 which is communicatively connected to the terminal device 12 via an input/output data stream 24 and to an optional database server/data store 26 for storing videos and loading at least one retrieved video via the bus system 22 into a computer-readable medium 28 by the one or more processors 20. Alternatively, a library of retrievable video clips may be stored directly in the computer readable medium 28. The computer readable medium 28 may also be used for storing the instructions of the system 10 to be executed by the one or more processors 20, including an operating system, such as the Windows or the Linux operating system and the video query expansion method of the present invention to be described hereinbelow. The computer readable medium 26 may include a combination of volatile memory, such as RAM memory, and non-volatile memory, such as flash memory, optical disk(s), and/or hard disk(s). In one embodiment, the non-volatile memory may include a RAID (redundant array of independent disks) system configured at level 0 (striped set) that allows continuous streaming of uncompressed data to disk without frame-drops. The input/output data stream 24 may feed images/video clips retrieved from at least one of the computer readable medium 28 and the database server/data store 26 to the display device 14.

Instead of retrieving videos in response to a query of a concept term based on external annotations of text, embodiments of the present invention reformulate or transform the query from keywords to a representative set of visual descriptors (properties) and their associated values, thereby harnessing a representation of visual information in sensor metadata stored with the video (Raw sensor metadata is data available as part of the actual video itself. Examples include geo-coordinates, time-of-day, and manual annotation. Other attributes may be derived or computed from sensor metadata stored with the video.). As a result, mappings between semantic information (i.e., concepts) and the sensor metadata are established.

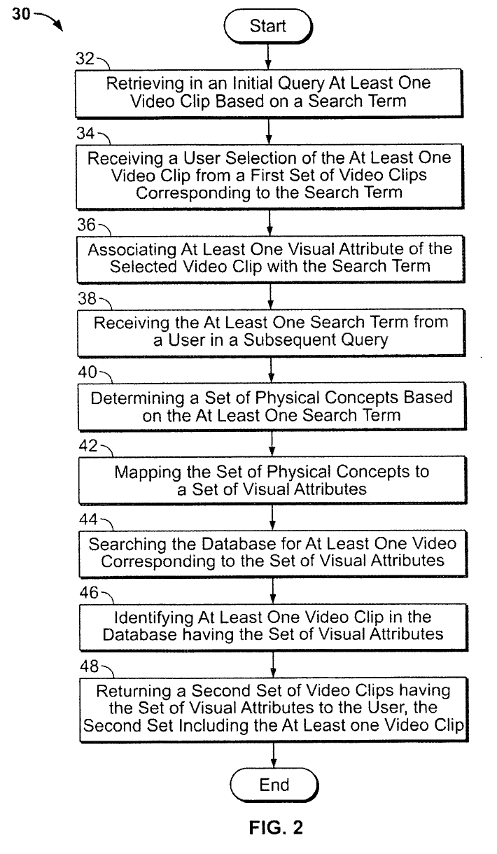

Referring now to FIG. 2, an illustrative embodiment of a computer implemented method for retrieving video clips from a database is depicted, generally indicated at 30. At step 32, as a result of a previous query for videos in a video database, a first set of (one or more) video clips are identified and presented to a user based on a search term input by the user. The previous query may have been initiated by the user or may have been initiated by another person. At step 34, the user selects one or more of the video clips returned in step 32. The feedback provided by the user may be implicit or explicit. The feedback is explicit when the user has explicit control over the feedback process, such as a button associated with a video clip in a menu that is labeled for submitting degree of relevance. In a preferred embodiment, the selection by the user is viewed as an implicit feedback by means of the selection of the video clip itself, such clicking on a link or still image representation of the video clip. At step 36, one or more visual attributes (visual properties and their associated values) are associated with the search term. As used herein, unless otherwise noted, the term “visual attribute(s)” refers to both a visual property and its associated value, also referred to as an “attribute value.” Exemplary visual properties may include, but are not limited to, “slant angle,” “view angle,” “ground sampling distance,” “speed”, “size,” “color,” “length,” “width,” “height,” etc. Examples of associated values may include “30 degrees” for the visual property “slant angle,” “blue” for the visual property “color,” etc. When only the associated value is meant, the term value or actual value may be used. The visual attributes may be derived from sensor metadata stored with the video.

In some embodiments, when one or more visual attributes are associated with a video clip during an initial query, the values of the visual attributes may be derived or calculated from one or more images in a collection of training video clips, which may or may not contain one or more of the video clips or video clip collection(s) in the database being queried at steps 32, 34. For a specific data collection, the attribute values computed over an aggregate of instances are referred to default values. Default values of visual attributes may be stored as slot-fillers in a knowledge base, such as a Protégé, application-specific knowledge base. Minimum and maximum values of default visual attributes may be pre-computed. A value corresponding to each of the visual attributes may be derived from metadata contained within a collection of training video clips. Using a rule-based inference system, such as Algernon, the Protégé knowledge base is queried and values are retrieved that have been pre-computed for a training video collection.

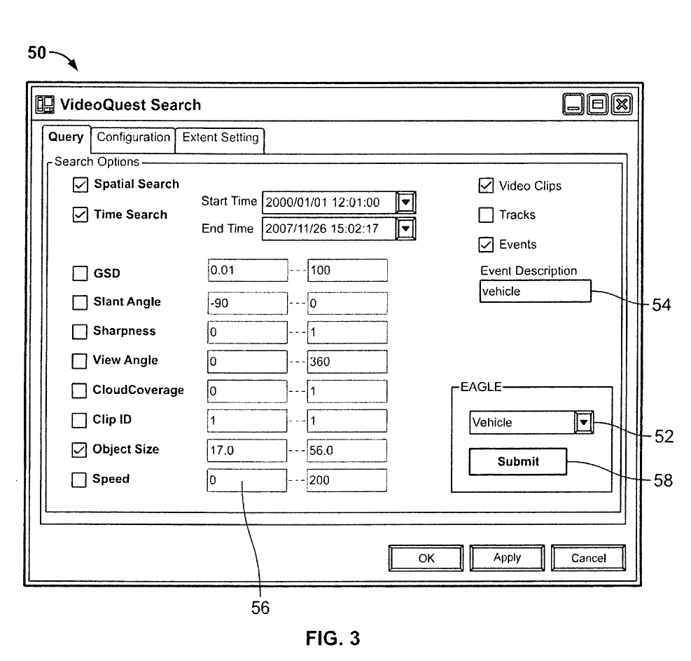

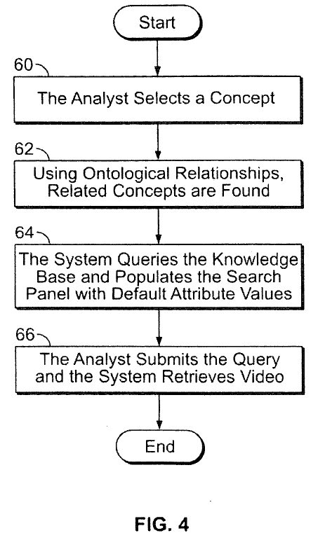

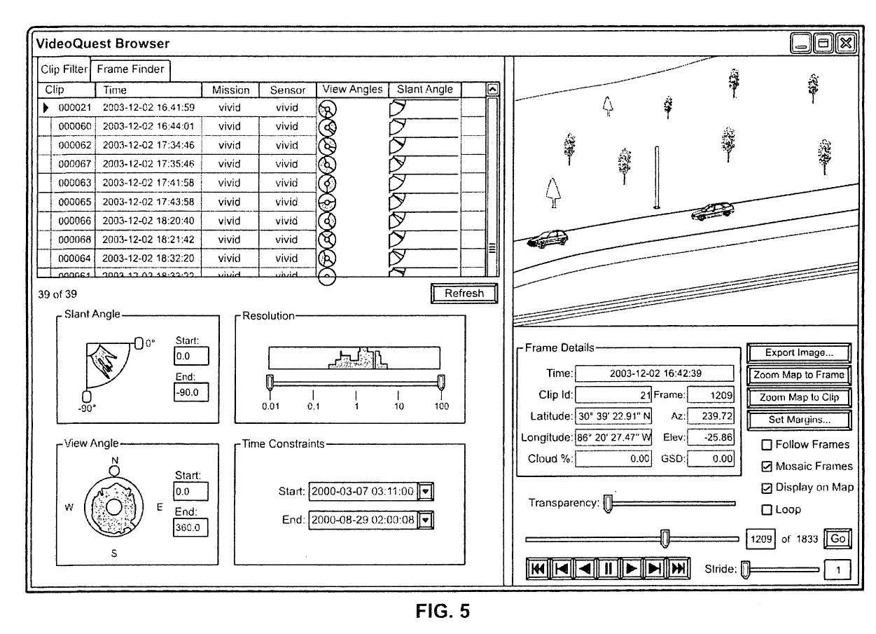

Referring now to FIGS. 3-5, an illustrative example of a search panel in an embodiment of the system of the present invention that shows the kinds of default visual attributes that can be returned in a query in real-time is presented in FIG. 3. The steps for populating the visual attributes are described in the flow of FIG. 4. At step 60, a user selects a concept using a pull down menu 52 or directly enters in a concept in an input field 54 of a search panel 50. At step 62, using ontological relationships, which may be inherited from a taxonomy (e.g., WordNet), related concepts are found, e.g., synonyms, if the concept entered has not been mapped to sensor metadata. At step 64, the system 10 of FIG. 1 queries the Protégé knowledge base and populates the search panel 50 with default attribute values in the fields 56 when available. At step 66, the user submits the query by clicking on the “Submit” button 58 and the system 10 conducts a search based on the query and retrieves one or more video clips for display via a result panel. A sample result panel is depicted in FIG. 5.

In other embodiments, the visual attributes may be derived directly from sensor metadata associated with selected video clip(s), or a combination of selected video clips and default values. In embodiments of the present invention, the values of visual attributes from selected video clips may replace one or more of the default values of the visual attributes in subsequent queries involving the same search term as previously entered. The selection of visual attribute values from current or prior selected video clips, or from previously calculated default values will be discussed in more detail hereinbelow.

Referring again to FIG. 3, the same or different user, in step 38, enters the same search term as part of a new or subsequent query. At step 40, a set of physical concepts based on the at least one search term is determined using a taxonomy such as WordNet (Examples of physical concepts are depicted by terms such as “vehicle” or “container.” Visual attributes for “vehicle” can be “speed” and for “container,” “length,” “width,” and “height”). Determining a set of physical concepts may further comprise finding synonyms of the search term for use in determining the set of physical concepts. At step 42, the set of physical concepts are mapped to a set of visual attributes. Mapping from a set of physical concepts (represented in the taxonomy) to a set visual attributes, i.e., visual properties or descriptors, does not require the user to know the underlying properties and their actual or default values, nor performing a translation manually. The mapping need not be defined for all concepts but may be inferred automatically. According to an embodiment of the present invention, using the taxonomy (WordNet) and an inference engine (Algernon), the properties of unmapped concepts may be inferred. For example, “truck” is a kind of “vehicle,” so “truck” may inherit the properties of “vehicle.” At step 44, the database is searched for at least one video clip corresponding to the set of visual attributes. At step 46, at least one video clip in the database having the set of visual attributes is identified. At step 48, the video clip(s) identified at step 32 and the video clip(s) identified in step 44, forming a second set of video clips and having the set of visual attributes, are returned to the user. In some embodiments, the video clip(s) identified at step 32 may be returned and displayed first before other retrieved video clips. The second set may contain fewer video clips than the first set.

When querying multiple video collections in the database, the range of values for a visual attribute may be the union of values that covers substantially all video clips having the visual attribute across the plurality of collections of video clips. The maximal set of values that cover all positive examples of video clips across the collections to form a search query is taken. For example, in collection 1, if the range of “slant angle” for “vehicle” is a subset of the range of “slant angle” in collection 2, then the two ranges are combined by taking the smallest maximal range that covers the possible values of “slant angle” of vehicles in collections 1 and 2 at query time. This may produce high recall at the expense of precision for the resulting set of retrieved video clips. In other words, all video clips that satisfy the “slant angle” constraint may be retrieved from both collections.

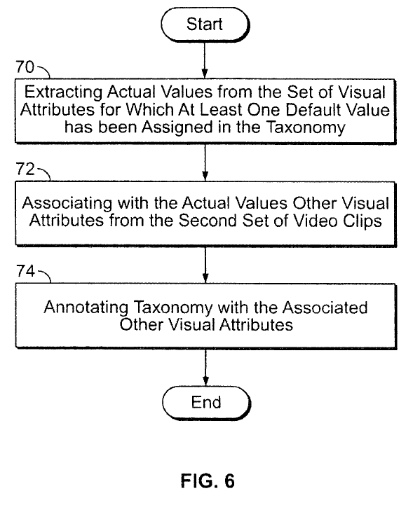

To increase the precision of the resulting set of retrieved video clips, query expansion can be extended by augmenting the mapping step 42 of FIG. 2 as depicted in the flow of FIG. 6. At step 70, the actual values from the set of visual attributes can be extracted from the set of visual attributes for which at least one default value has been assigned in the taxonomy. One or more of the set of visual attributes may be associated with the selected video clip. In other words, the actual value of “slant angle,” “speed,” etc., for all known visual properties in the selected video clip(s) may be substituted in place of default values within the set of visual attributes. At step 72, other visual attributes of the selection video clip(s) may be associated with the actual values, i.e., other properties of concepts in the selected video clip(s) can be associated with the actual values determined in step 70. For example, if the user selected “clip1” and “clip2,” each of which was retrieved with “keyword1” (representing some concept), then all known visual attributes of “clip1” and “clip2,” including the actual values of step 70, become associated visual attributes for an instance of the concept represented by “keyword1.” At step 74, the other associated visual attributes are used to annotate the taxonomy (in some embodiments, concept nodes in GVIO). This is an automated way to update (through annotation) and grow (by adding relevant content) the taxonomy. The generation of values of visual attributes also helps to disambiguate concepts in the taxonomy by specializing values associated with super-ordinate (ancestor) concepts in the taxonomy.

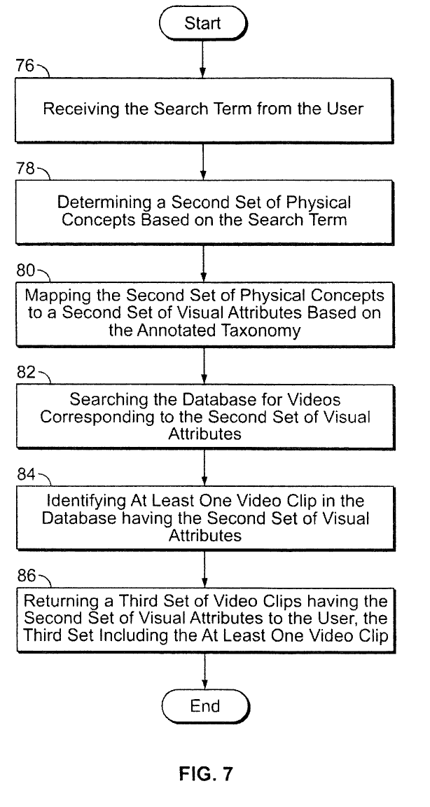

The results of step 74 (i.e., associating the values of visual attributes and video clips selected for a concept) may be available for the expansion (or generation) of queries in future searches. For example, during the next search session using the same search term, the user may be presented with a choice of previously selected video clips and associated property values as well as the original search screen populated with default values. An embodiment of query expansion in subsequent searches of the same concept is illustrated in the flow of FIG. 7.

At step 76, the same search term previously entered in an initial query is received by the system. At step 78, a second set of physical concepts based on the at least one search term is determined. This second set of physical concepts is derived from the expansion of concepts determined in step 72 of FIG. 6. At step 80, the second set of physical concepts is mapped to a second set of visual attributes based on the annotated taxonomy. At step 82, the database is searched for at least one video corresponding to the second set of visual attributes. At step 84, one or more video clips in the database having the second set of visual attributes is found. At step 86, a third set of video clips having the second (expanded) set of visual attributes is returned to the user. The third set may contain fewer video clips than the second set of FIG. 3.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A computer implemented method for retrieving video clips from a database, comprising the steps of:
retrieving in an initial query from a video collection based on a search term;
receiving a user selection of at least one video clip from a first set of video clips corresponding to the search term;
associating at least one visual attribute of the selected video clip with the search term;
receiving the at least one search term from a user in a subsequent query;
determining a set of physical concepts based on the at least one search term;
mapping the set of physical concepts to a plurality of visual attributes;
searching the database for at least one video clip corresponding to the plurality of visual attributes;
identifying at least one video clip in the database having the plurality of visual attributes; and
returning a second set of video clips having the set of visual attributes to the user, the second set including the at least one video clip.

2. The method of claim 1, wherein the second set contains fewer video clips than the first set.

3. The method of claim 1, wherein said steps of determining a set of physical concepts and mapping the set of physical concepts are performed using a taxonomy and an inference engine.

4. The method of claim 3, further comprising the step of querying a plurality of collections of video clips in the database, wherein the range of values for a given visual attribute is the union of values that covers substantially all video clips having said given visual attribute across the plurality of collections of video clips.

5. The method of claim 1, wherein at least one of the plurality of visual attributes is derived from sensor metadata stored with at least one of the second set of video clips.

6. The method of claim 1, wherein at least one of the plurality of visual attributes is associated with the selected at least one video clip.

7. The method of claim 1, further comprising the steps of:
extracting at least one actual value of at least one of the plurality of visual attributes for which at least one default value has been assigned in the taxonomy;
associating with the at least one actual value at least one other visual attribute from the second set of video clips; and
annotating the taxonomy with the associated at least one other visual attribute.

8. The method of claim 7, further comprising the steps of:
receiving the at least one search term from the user;
determining a second set of physical concepts based on the at least one search term;
mapping the second set of physical concepts to a second plurality of visual attributes based on the annotated taxonomy;
searching the database for at least one video corresponding to the second plurality of visual attributes;
identifying at least one video clip in the database having the second plurality of visual attributes; and
returning a third set of video clips having the second plurality of visual attributes to the user, the third set including the at least one video clip.

9. The method of claim 1, wherein the third set contains fewer video clips than the second set.

10. The method of claim 1, further comprising the step of assigning a default value to at least one of the plurality of visual attributes, the default value being computed based on a collection of training video clips.

11. The method of claim 1, further comprising the step of pre-computing minimum and maximum values of at least one of plurality of visual attributes.

12. The method of claim 1, wherein at least one value corresponding to at least one of the plurality of visual attributes is derived from metadata contained within a collection of training video clips.

13. The method of claim 1, wherein the step of determining a set of physical concepts further comprising the step of finding synonyms of the search term for use in determining the set of physical concepts.

14. An apparatus for retrieving video clips from a database, comprising:
a processor configured for executing instructions comprising the steps of:
retrieving in an initial query from a video collection based on a search term;
receiving a user selection of at least one video clip from a first set of video clips corresponding to the search term;
associating at least one visual attribute of the selected video clip with the search term;
receiving the at least one search term from a user in a subsequent query;
determining a set of physical concepts based on the at least one search term;
mapping the set of physical concepts to a plurality of visual attributes;
searching the database for at least one video clip corresponding to the plurality of visual attributes;
identifying at least one video clip in the database having the plurality of visual attributes; and
returning a second set of video clips having the set of visual attributes to the user, the second set including the at least one video clip.

15. The apparatus of claim 14, wherein the second set contains fewer video clips than the first set.

16. The apparatus of claim 14, wherein said steps of determining a set of physical concepts and mapping the set of physical concepts are performed using a taxonomy and an inference engine.

17. The apparatus of claim 16, wherein the processor is further configured for executing instructions comprising the step of querying a plurality of collections of video clips in the database, wherein the range of values for a given visual attribute is the union of values that covers substantially all video clips having said given visual attribute across the plurality of collections of video clips.

18. The apparatus of claim 14, wherein at least one of the plurality of visual attributes is derived from sensor metadata stored with at least one of the second set of video clips.

19. The apparatus of claim 14, wherein at least one of the plurality of visual attributes is associated with the selected at least one video clip.

20. The apparatus of claim 14, wherein the step further comprises the steps of:
extracting at least one actual value of at least one of the plurality of visual attributes for which at least one default value has been assigned in the taxonomy;
associating with the at least one actual value at least one other visual attribute from the second set of video clips; and
annotating the taxonomy with the associated at least one other visual attribute.

21. The apparatus of claim 20, wherein the processor is further configured for executing instructions comprising the steps of:
receiving the at least one search term from the user;
determining a second set of physical concepts based on the at least one search term;
mapping the second set of physical concepts to a second plurality of visual attributes based on the annotated taxonomy;
searching the database for at least one video corresponding to the second plurality of visual attributes;
identifying at least one video clip in the database having the second plurality of visual attributes; and
returning a third set of video clips having the second plurality of visual attributes to the user, the third set including the at least one video clip.

22. The apparatus of claim 21, wherein the third set contains fewer video clips than the second set.

23. A computer-readable medium carrying one or more sequences for retrieving video clips from a database, wherein execution of the one of more sequences of instructions by one or more processors causes the one or more processors to perform the steps comprising:
retrieving in an initial query at least one video clip from a video collection based on a search term;
receiving a user selection of at least one video clip from a first set of video clips corresponding to the search term;
associating at least one visual attribute of the selected video clip with the search term;
receiving the at least one search term from a user in a subsequent query;
determining a set of physical concepts based on the at least one search term;
mapping the set of physical concepts to a plurality of visual attributes;
searching the database for at least one video clip corresponding to the plurality of visual attributes;
identifying at least one video clip in the database having the plurality of visual attributes; and
returning a second set video clips having the set of visual attributes to the user, the second set including the at least one video clip.

24. The computer-readable medium of claim 23, wherein the second set contains fewer video clips than the first set.

25. The computer readable medium of claim 23, wherein said steps of determining a set of physical concepts and mapping the set of physical concepts are performed using a taxonomy and an inference engine.

26. The computer readable medium of claim 23, wherein the one or more processors are further configured to perform the step comprising querying a plurality of collections of video clips in the database, wherein the range of values for a given visual attribute is the union of values that covers substantially all video clips having said given visual attribute across the plurality of collections of video clips.

27. The computer readable medium of claim 23, wherein at least one of the plurality of visual attributes is derived from sensor metadata stored with at least one of second set of video clips.

28. The computer readable medium of claim 23, wherein at least one of the plurality of visual attributes is associated with the selected at least one video clip.

29. The computer readable medium of claim 23, further comprises the steps of:
extracting at least one actual value of at least one of the plurality of visual attributes for which at least one default value has been assigned in the taxonomy;
associating with the at least one actual value at least one other visual attribute from the second set of video clips; and
annotating the taxonomy with the associated at least one other visual attribute.

30. The computer readable medium of claim 29, wherein the one or more processors are further configured to perform the steps comprising:
receiving the at least one search term from the user;
determining a second set of physical concepts based on the at least one search term;
mapping the second set of physical concepts to a second plurality of visual attributes based on the annotated taxonomy;
searching the database for at least one video corresponding to the second plurality of visual attributes;
identifying at least one video clip in the database having the second plurality of visual attributes; and
returning a third set of video clips having the second plurality of visual attributes to the user, the third set including the at least one video clip.

31. The computer-readable medium of claim 30, wherein the third set contains fewer video clips than the second set.
